(19) United States
(12) Patent Application Publication
(10) Pub. No.: US 2008/0272350 A1
(43) Pub. Date: Nov. 6, 2008

(54) Device for Conduiting and Piping and a Shuttle

(76) Inventor: Ming-Chun Lu, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/114,555

(22) Filed: May 2, 2008

(30) Foreign Application Priority Data
May 4, 2007 (TW) 096207120

(51) Int. Cl. H02G 1/08

(52) U.S. Cl. 254/134.3 FT

(57) ABSTRACT

The present invention relates to an apparatus for conduiting and piping, comprising (1) a device to produce negative pressure, and (2) a shuttle, comprising a body, to link a conducting wire on its rear end. The present invention also relates to a shuttle for conduiting and piping.

### FIELD OF THE INVENTION

The present invention relates to an apparatus for pipe wiring.

### BACKGROUND OF THE INVENTION

Currently in electrical engineering, when cables (usually polyvinyl chloride conductive cables or electrical magnetic tubes) are being wired, a strainer comprising a snap ring at its head for attachment to nylon guide lines must be used. The head of the strainer is pushed all the way from one end of the pipe to the other end, the nylon guide line is tied to the snap ring at the head, and the head is then pulled back to the original end of the pipe. Afterwards, this nylon guide line can be used for the desired wiring scheme. This operation normally requires a group of two workers, one at each end of the pipe, and involves three steps: 1) pushing the head of the strainer through the pipe, 2) tying a nylon guide line at the head of the strainer and pulling it back to thread the guide line through the pipe, and 3) tying a cable to the front of the guide line and pulling the cable through the pipe.

The flaw of this method is that the maximum distance for each individual piping is limited by the hardness of the strainer, the curvature and circularity of the pipe, and the evenness at the junction of adjacent pipes, so that the maximum distance rarely surpasses 30 meters. In addition, the efficiency of this operation is substantially dependent on the skills of the worker. If an operation distance of 100 meters is desired, it must be done at several intervals, and junction-boxes could be required. Besides, since a minimum group of two is needed, labor costs are relatively high. If the wiring is to be done on ceilings, the time and labor costs will rise with the operational difficulty.

In recent years an alternative method has been developed; it utilizes carbon dioxide of high positive pressure to propel a bullet-like object connected to a nylon guide line from one end of the tube to the other. When this object reaches the other end, the attached nylon guide line is used for the subsequent wiring. Under better conditions, 30 to 40 meters could be covered under a single operation. This operation comprises of two steps: 1) threading of the nylon guide line through the pipe by the propelling the bullet-like object, and 2) tying an electrical cable to the guide line and pulling the cable through the pipe.

However, there are several flaws in this method. The bullet-like object is often composed of harder materials, has substantial weight in order to achieve enough kinetic energy, and ample carbon dioxide must be accumulated. When the bullet-like object is ejected, its kinetic energy is able to keep it going for a maximum of around 40 meters, provided that the pipe is straight and the connecting junctions are smooth. Yet in actual situations, the pipe is often curved and has poor circularity and the junctions are usually uneven. In addition, carbon dioxide is released only once per operation. Therefore when the bullet-like object is shot, its kinetic energy drastically decreases, leaving it stuck in the pipe. To make matters worse, the trailing nylon line keeps moving forward even when the bullet-like object has stopped due to inertia, resulting in a tangled mess of lines.

Still another flaw in this method is the pressurized carbon dioxide. It is special material that cannot be easily obtained, and the recharging costs are high. It is packaged in heavy steel cylinders which are inconvenient to carry and its usage poses potential hazards (The force of the ejected gas or bullet-like object could be too strong and the tied nylon line could cut the workers.). Furthermore, the stored gas in the steel cylinder is limited and is unable to sustain long term usage, and recharging of the gas on the scene is impossible. Due to the aforementioned flaws, this kind of pressurized-carbon-dioxide-propelled wiring method is not widely adopted.

As a result, it requires a device solving the aforementioned problems is in need.

### SUMMARY OF THE INVENTION

The present invention provides a device used for pipe wiring, comprising a shuttle placed at an end of the pipe to be wired that includes a shuttle body which is attached to a guide line at its rear end; and a negative pressure generator attached to the other end of the pipe to be wired to produce a suction force and draw the shuttle and the attached nylon guide line through the pipe.

The present invention further provides a shuttle used for pipe wiring which comprises a shuttle body that is connected to a guide line at its rear side and is encircled by at least one side fin.

### BRIEF DESCRIPTION OF THE DRAWINGS

FIG. 1 shows a device used for pipe wiring.

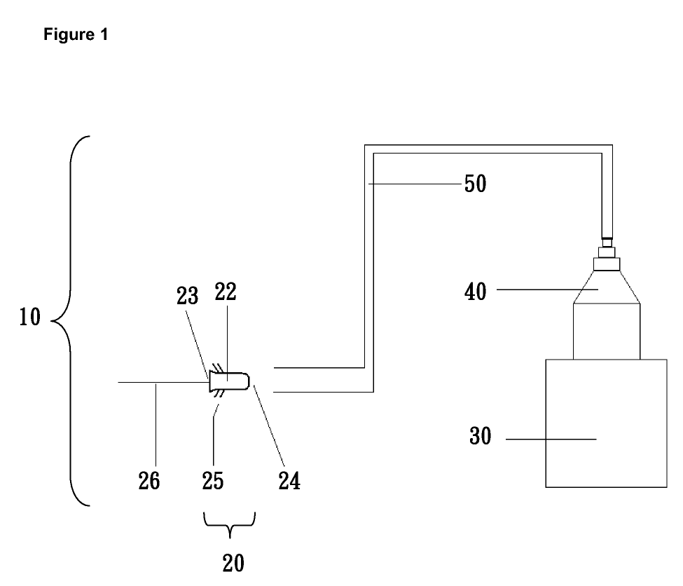

### DESCRIPTION OF MAJOR PARTS IN THE PRESENT INVENTION

10: A device of the present invention

20: The entirety of the shuttle, including the body, the front end, the rear end, and the side fins

22: The body of the shuttle

23: The rear end of the shuttle

24: The front end of the shuttle

25: Side fin

26: Nylon guide line

30: Negative pressure-generating device

40: Joint

50: Tube used for wiring

### DETAILED DESCRIPTION OF THE INVENTION

Term Definition

Shuttle includes front and rear ends that could be used to draw other components of the guide line. The shuttle has side fins on its side that can fit tightly to the pipe to maintain an airtight condition.

Guide line can be made of nylon or other light materials, and is attached to the rear end of the shuttle and can be sucked to the end of the pipe with the shuttle by negative pressure.

Side fins are attached to the side of the shuttle and comprise one or more separating rifts that promote an airtight condition and stabilization of air flow.

Rear end is the part of the shuttle that can be attached to the guide line.

Front end is the other part of the shuttle that can be attached to the guide line.

The present invention presents a device for use in pipe wiring; it includes a negative pressure generator (30), a shuttle (20) used for pipe wiring, comprising the shuttle body (22) which is attached to a guide line (26). The shuttle body (22) is encircled by at least one side fin (25).

The present invention provides a joint (40), which could be composed of several tubes of different calibers that are piled up from wide to narrow. It could be used to connect the negative pressure generator (30) to construction pipes of various calibers to achieve an airtight condition.

The present invention mentions a negative pressure generator (30) which can produce a suction force from negative pressure; this negative pressure generator could comprise a blower operated in the reverse direction or a vacuum.

The present invention mentions a guide line (26) that could be composed of lightweight and sturdy material such as cotton/linen blended fibers, nylon strings or fishing lines, in order to minimize the rate of kinetic energy loss and promote operational efficiency.

The present invention also mentions a shuttle (20) which is made of material of good elasticity and softness such as synthetic rubber or foam rubber; the shuttle (20) also comprises a hard material that covers its front end; this hard material could be hard plastic or malleable metals. This design is to overcome the the curvature and unevenness of the construction pipes. The diameter of the shuttle (20) could be designed to complement the caliber of the pipes, in order to obtain an airtight condition. The front side of the shuttle is curved to lower the friction between the shuttle (20) and the pipe, air resistance and to minimize loss of kinetic energy. The shuttle (20) contains at least one side fin (25) that surrounds the shuttle body (22), and the diameter of the side fin is slightly bigger than that of the shuttle body (22), so that elasticity and airtight conditions are maintained when the shuttle goes around a turn in the pipe.

The side fin (25) mentioned in the present invention could be composed of synthetic rubber, foam rubber or other soft and elastic materials. This side fin (25) can be gasket-shaped and encircles the shuttle body (22) or can be made as a tail fin that is attached between the front side (24) and back side (23) of the shuttle. This design enables the shuttle to overcome curvature and unevenness of the pipes. The side fin (25) could be designed with or without rifts, depending on the shape of the pipes, to provide an airtight condition and stabilization of air flow, enabling the shuttle to run smoothly in the pipe.

The present invention also reveals a technique used for pipe wiring that includes the following steps: placing a shuttle attached to a guide line at the front end of a construction pipe; connecting a negative pressure generator at the rear end of the construction pipe; turning on this negative pressure generator to produce a suction force; pass the shuttle along with the attached guide line into the front end and allow it to be sucked by the negative pressure to the rear end; detaching the guide line from the shuttle, reattaching it to the end of the desired cable, and pulling it back to the front end of the tube to finish the wiring process. This operation procedure only requires one person to complete, and can easily cover 100 meters of pipe length; if the conditions of the pipe are optimal (such as having a suitable caliber), wiring up to 150 meters of cable during a single operation is also feasible. This greatly saves time and labor costs.

The present invention also provide a shuttle (20) used for pipe wiring, comprising a shuttle body (22), whose rear end (23) can be attached to a guide line (26). This shuttle body is also encircled by at least one side fin (25).

The present invention has the following advantages compared to conventional methods: The propelling force is generated by a small high speed blower operated in reverse direction, which could be powered by household electrical outlet; therefore the generated negative pressure is stable and continuous.

The shuttle is made of materials such as synthetic or foam rubber which are highly elastic; its shape can be designed to complement the caliber of the pipe to provide superior airtight conditions. It can also easily turn around curves in the pipe so that an airtight condition and the negative pressure is maintained.

The shuttle also comprises at least one side fin that could be designed with or without rifts, depending on the shape of the pipes, to provide an airtight condition and stabilization of air flow, enabling the shuttle to run smoothly in the pipe.

Due to the excellent airtight condition of the shuttle and the stable and continuous source of negative pressure, the negative pressure need not be too big. A single small high speed blower is enough to provide the required power, and due to the portability of the blower it can be viewed as a personal electrical appliance that can be easily brought to the construct site.

The shuttle can be designed with different shapes and degrees of hardness to complement the various calibers and textures of the tubes.

The shuttle is made of soft and elastic material that can overcome the curvatures of the tube.

The shuttle is made of soft and elastic material that can overcome the unevenness of the tube.

Saves time and labor costs.

Since the nylon guide line is also brought to the other end of the tube with the shuttle, time is saved for not having to draw the guide line back to the original end.

Easy to operate and little training required.

### EXAMPLES

### Example 1

### Operational Steps

Preceding operation: the pipes (50) desired for wiring was measured to make sure that its length is no longer than the maximum of 100 to 150 meters, and a small high speed blower (30) was attached to one end of the pipe. The blower was then turned on and the other end of the pipe was checked for the presence of negative pressure. If negative pressure was absent, it might have been because of a blockade in the pipes or loose junctions.

Propelling of the nylon guide line (26): the small high speed blower was turned off after confirmation of negative pressure, and the shuttle (20) with the nylon guide line attached to its rear end (23) was plugged into the end of the pipe opposite to the blower. The blower (30) was then turned on to generate negative pressure, drawing the shuttle (20) and the nylon guide line (26) all the way through the pipe to the end where the blower was placed.

Retraction of the nylon guide line (26) and drawing of the cable: after the shuttle (20) and the nylon guide line (26) has moved through the pipe (50), they were unattached and the nylon guide line (26) was reattached to the cable. The nylon guide line (26) was retracted to its source, pulling the cable back at the same time until the whole cable passes through the pipe to complete the whole operation.

What is claimed is:

1. A device for use in pipe wiring, comprising:
(a) a shuttle placed at an end of the pipe to be wired that includes a shuttle body which is attached to a guide line at its rear end; and
(b) a negative pressure generator attached to the other end of the pipe to be wired to produce a negative pressure to draw the shuttle and the attached nylon guide line through the pipe.

2. The device of claimed in claim 1, wherein the shuttle body is encircled by at least one side fin.

3. The device of claim 1, wherein the negative pressure generator further comprises a joint used to connect the negative pressure generator to construction pipes of various calibers to achieve an airtight condition.

4. The device of claim 3, wherein the joint is prepared by several tubes of different calibers that are piled up from wide to narrow.

5. The device of claim 1, wherein the negative pressure generator generates a negative pressure suction force that is stable and continuous.

6. The device of claim 5, wherein the negative pressure generator is a blower operated in reverse direction or a vacuum.

7. The device of claim 1, wherein the guide line is cotton and linen blended fibers, nylon strings or fishing lines

8. The device of claim 1, wherein the shuttle is made of material of good elasticity and softness.

9. The device of claim 8, wherein the shuttle is made of synthetic rubber or foam rubber.

10. The device of claimed in claim 8, wherein the shuttle further comprises a hard material that covers its front end.

11. The device of claim 10, wherein the hard material is hard plastic or malleable metals

12. The device of claim 1, wherein the front side of the shuttle is curved to reduce the friction between shuttle and the pipe.

13. The device of claim 2, wherein the side fin comprises one or more separating rifts that promote an airtight condition and stabilization of air flow.

14. The device of claim 2, wherein the side fin is made of soft and elastic materials.

15. The device of claim 2, wherein the side fin is made of synthetic rubber or foam rubber.

16. A shuttle for use in pipe wiring comprising a shuttle body that is connected to a guide line at its rear side and is encircled by at least one side fin.

17. The shuttle of claim 16, wherein the rear end of the shuttle is attached to nylon guide line or a cable.

18. The shuttle of claim 16, wherein the shuttle is made of material of good elasticity and softness.

19. The shuttle of claim 16, wherein the shuttle is made of synthetic rubber or foam rubber.

20. The shuttle of claim 18, wherein the shuttle further comprises a hard material that covers its front end.

21. The shuttle of claim 20, wherein the hard material is hard plastic or malleable metals.

22. The shuttle of claim 16, wherein the front side of the shuttle is curved to lower the friction between shuttle and the pipe.

23. The shuttle of claim 16, wherein the side fin comprises one or more separating rifts that promote an airtight condition and stabilization of air flow.

24. The shuttle of claim 16, wherein the side fin is made of soft and elastic materials.

25. The shuttle of claimed in claim 16, wherein the side fin is made of synthetic rubber or foam rubber.
